(19) United States
(12) Patent Application Publication
(10) Pub. No.: US 2018/0022227 A1
(43) Pub. Date: Jan. 25, 2018

(54) BATTERY CHARGING SYSTEMS AND ASSOCIATED METHODS OF USE

(71) Applicant: FAA, LLC, Merritt Island, FL (US)

(72) Inventor: Dennis Foldesi, Merritt Island, FL (US)

(21) Appl. No.: 15/547,179

(22) PCT Filed: Jan. 28, 2016
(86) PCT No.: PCT/US16/15252

§ 371 Date: Jul. 28, 2017

Related U.S. Application Data
(60) Provisional application No. 62/109,361, filed on Jan. 29, 2015.

(51) Int. Cl. B60L 11/18; H02J 3/32; H02J 7/00

(52) U.S. Cl. CPC B60L 11/1842; B60L 11/185; B60L 11/1812; H02J 7/0024; H02J 3/32; B60L 2210/40; B60L 2210/30

(57) ABSTRACT

Various embodiments of a battery charging system are disclosed herein. In one embodiment, an electric vehicle includes a battery charging system, a power source, and a motor. The battery charging system includes a charging module for converting power from an external power source into power that can be stored by the power source and/or used by the motor. The battery charging system can switch or reverse the flow of power between the power source and the external power source during a power outage to power electrical loads of a house.

### PRIORITY CLAIM

This application is a 371 U.S. National Stage Application of International PCT Application No. PCT/US16/15252 filed on Jan. 28, 2016, which claims priority from U.S. Provisional Application Ser. No. 62/109,361 filed Jan. 29, 2015, the entirety of each of which are incorporated by reference herein.

### TECHNICAL FIELD

The present technology relates generally to battery charging systems and, more particularly, to battery charging systems for electric vehicles that can be configured to provide backup power to a home.

### BACKGROUND

Various types of charging systems are known for charging a rechargeable battery (e.g., of an electric and/or hybrid vehicle). A rechargeable battery can be used in, for example, a vehicle to provide power for propulsion or other electrical systems of the vehicle. Typically, the charging systems are connected to an external source of power (e.g., an electric utility grid) via one or more cables. The external source of power can provide electric power in the form of alternating current (AC) power to recharge the battery. A charging system can include a charger or other device configured to receive and convert the AC power to direct current (DC) power to be stored in and/or charge the battery.

### BRIEF DESCRIPTION OF THE DRAWINGS

FIG. 1 is a schematic diagram of an electric vehicle having a battery charging system configured in accordance with an embodiment of the present technology.

FIG. 2 is a schematic diagram of the electric vehicle of FIG. 1 coupled to electrical loads of a home configured in accordance with an embodiment of the present technology.

FIG. 3 schematically illustrates an example method for operating a battery charging system configured in accordance with an embodiment of the present technology.

### DETAILED DESCRIPTION

The present technology describes various embodiments of battery charging systems that can be configured to provide power to electrical devices or loads (e.g., of a house) during power outages, shutdowns, emergencies and/or where a main or normal power supply (e.g., provided by a utility) is down, unavailable, and/or unreliable. In one embodiment, for example, a battery charging system is configured to be connected or is connected to an external power source or supply (e.g., power supplied by a utility or other commercial provider) and a battery (e.g., rechargeable) of a vehicle (e.g., electric or hybrid). The battery charging system can use the power provided by the external power source to recharge the battery when the battery is connected to the power source via the battery charging system (e.g., through one or more cables or other connectors).

The battery charging system can also be configured to provide or provides backup and/or emergency power to a house to run the various electrical loads (e.g., systems and devices) of the house during a power outage. The battery charging system can reverse (e.g., switch) the flow of power (e.g., between the battery and the house) such that power flows from the battery to power the electrical devices or loads of the house. As described in greater detail below, the battery charging system can also include other features to enhance operation and/or improve functionality. Such features can include, for example, one or more sensors for sensing a power outage and signaling to the battery charging system to reverse (e.g., switch) the flow of power. Another feature can include a switch that automatically reverses the flow of power to and/or from the battery when the one or more sensors sense a power outage and/or when the batteries are drained.

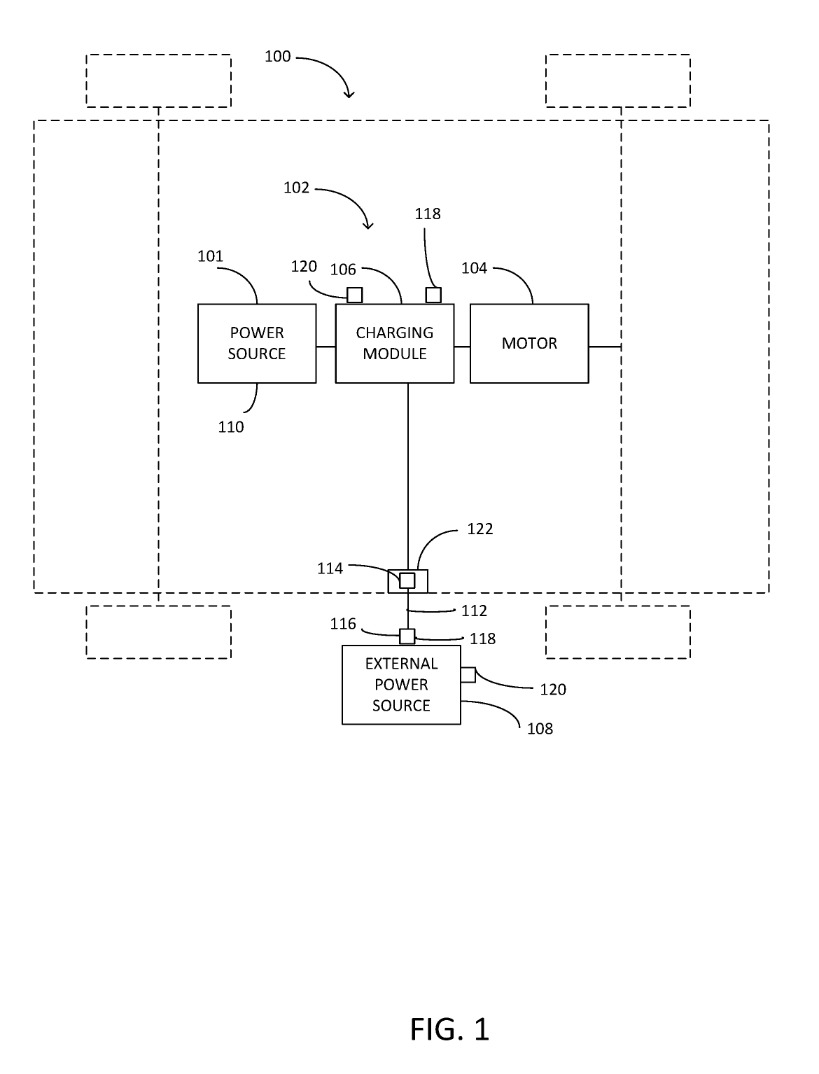

Certain details are set forth in the following description and in FIGS. 1-3 to provide a thorough understanding of various embodiments of the present technology. Other details describing well-known structures and systems often associated with battery charging systems and electric vehicles including connectors, chargers, power supplies, electric vehicle management systems, charging circuits, rectifiers, transistors, cables, switches, inverters, converters, batteries, sensors, controllers, circuits, user interfaces and propulsion, electrical, or heating and cooling systems, etc. have not been set forth in the following disclosure to avoid unnecessarily obscuring the description of the various embodiments of the present technology.

Many of the details, dimensions, angles and other features shown in the Figures are merely illustrative of particular embodiments of the present technology. Accordingly, other embodiments can add other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 illustrates a schematic diagram of a vehicle 100 and other various components of the vehicle 100 that the battery charging system 102 can be integrated with, positioned within and/or connected to according to various embodiments of the present technology. In various embodiments, the vehicle 100 can be an electrical vehicle. Electric vehicles include vehicles that typically include one or more power sources 101 (e.g., batteries 110) configured to store and provide power to propel the vehicle and/or power other onboard electrical devices or systems. Electrical vehicles can include automobiles, trucks, boats, jet skis, utility or all-terrain vehicles, forklifts, etc. In other embodiments, the vehicle 100 can include a hybrid vehicle.

In the illustrated embodiment, the vehicle 100 is an electric vehicle (e.g., manufactured by Tesla, Chevrolet, Nissan, Toyota, Honda, BMW, Fiat, Hyundai, Ford or other manufacturers) and includes a power source 101 (e.g., one or more batteries 110) and at least one motor 104. The motor 104 is configured to convert or converts power supplied by the power source 101 into mechanical motion (e.g., motion to move or propel the vehicle 100). The power source 101 can be connected to the battery charging system 102.

In one embodiment, the battery charging system 102 is able to receive a supercharge and/or to provide a supercharge to a supercharge-capable vehicle 100, for example as described in U.S. Pat. No. 8,643,330, hereby incorporated by reference herein in its entirety. In one embodiment, the battery charging system 102 can deliver at least about 100 kW, at least about 110 kW, at least about 120 kW or at least about 130 kW of direct current power directly to the power source 101. In one embodiment, the battery charging system 102 is configured to gradually reduce current supplied to the power source 101 as the power source nears a full charge (e.g. at least 80%, at least 85% at least 90% or at least 95%).

In one embodiment, the battery charging system 102 is able to deliver a full charge of at least about 250, at least about 255, at least about 265, at least about 275, at least about 285, at least about 300, at least about 350 or at least about 400 miles of driving to an 85 kWh vehicle in 80 minutes or less, 75 minutes or less, 70 minutes or less, 65 minutes or less, 60 minutes or less, 55 minutes or less, 50 minutes or less, 45 minutes or less, 40 minutes or less, 35 minutes or less or 30 minutes or less.

In one embodiment, the battery charging system 102 comprises a system that allows for distributing charging power among a plurality of charge ports 122 (a, b, c, etc.,) of the battery charging system 102, where the battery charging system 102 includes a plurality of power stages 130-132 where each power stage 130-132 includes an AC to DC converter and wherein each power stage 130-132 provides a portion of the charging system's maximum available charging power.

In one embodiment, the plurality of parallel power stages are grouped together into groups of three forming a power block. For example power stages 130-132 are grouped together into power block 140; power stages 133-135 are grouped together into power block 141 and power stages 136-139 are grouped together into power block 142. Grouping into blocks of three helps to insure that the three phase AC side remains balanced. If imbalance is allowed, then the power stages need not be grouped together, thus allowing power distribution into smaller discrete power steps.

The power source 101 is configured to store or stores power that can be delivered (e.g., supplied or provided) to the motor 104 (e.g., directly or indirectly through a charging module 106, inverter, and/or converter, etc.) for propelling the vehicle 100 and/or other electrical systems and devices (e.g., a vehicle management system, display system, HVAC system) of the vehicle 100. In the illustrated embodiment, the power source 101 includes one or more rechargeable batteries 110. The rechargeable battery 110 can include one or more battery cells that are electrically coupled to form the rechargeable battery 110. In some embodiments, the rechargeable battery 110 includes one or more lithium ion batteries coupled in parallel and/or series.

Referring to FIG. 1, in one aspect of this embodiment, the battery charging system 102 includes one or more charging modules 106 (e.g., power converters, charging stations, inverters, power supplies and/or rectifiers, etc.) positioned on-board and/or inside the vehicle 100 and connected to the power source 101. In other embodiments, the charging module 106 can be positioned or located outside of the vehicle 100. The charging module 106 is configured to convert or converts power (e.g., 110V AC power, 220V AC power, 240V AC power) transmitted from an external power source 108 (e.g., power from a utility grid of a house via an outlet, circuit, and/or panel, etc. and/or power from a charging or supercharging station) into power (e.g., DC power) storable by the power source 101 (e.g., the battery 110) to recharge the power source 101. In some embodiments, the charging module 106 can also be configured to convert DC power supplied by the power source 101 to AC power that is useable by the motor 104 to propel the vehicle. In other embodiments, a separate inverter, rectifier or converter can be used to convert the DC power supplied by the power source 101 into AC power for the motor 104. In some embodiments, the motor 104 can be configured to run on DC power. In some embodiments, the charging module 106 can monitor and control the charging of the power source 101 (e.g., voltage, charging rate, temperature of the power source 101).

The charging module 106 can be connected to the external power source 108 via one or more detachable connectors 112 (e.g., cables). For example, the connector 112 can include a first plug 114 on one end for connection to the vehicle 100 (e.g., via a charge port 122 that is electrically coupled to the charging module 106) and a second plug 116 on an opposite end of the connector 112 for connection to external power source 108, e.g., via an electrical outlet (e.g., a 110V standard household outlet or a 240V NEMA 14-50 outlet) such that power can flow between the external power source 108 and the charging module 106. In some embodiments, the connector 112 includes a wall connector 118 on the opposite end of the connector 112 for installation to the external power source 108 via a 240V circuit (e.g., of an electrical grid of a house). In other embodiments, the connector 112 connects the charging module 106 to the external power source 108 that is a charging or supercharging station (e.g., by Tesla or other manufacturers) away from a house.

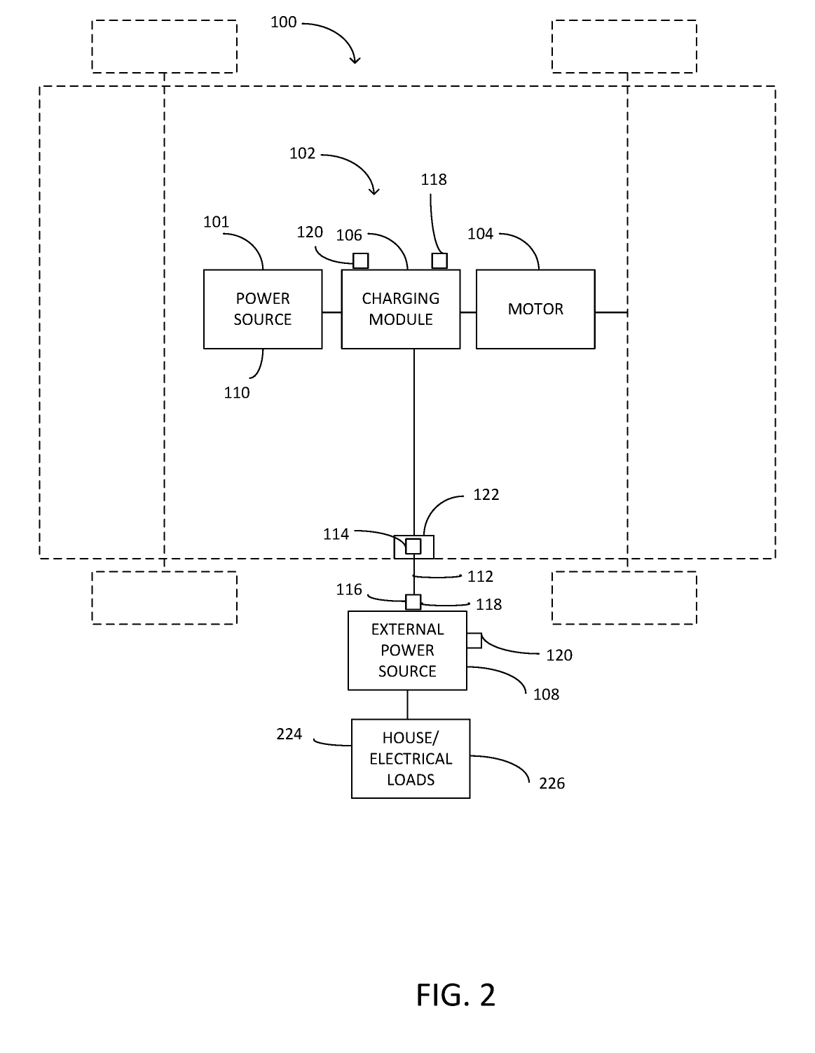

The power source 101 is configured to supply or supplies (e.g., transmits) power (e.g., backup power) when a flow of power is reversed (e.g., switched) from charging the power source 101 to being drawn off the power source 101. For example, as illustrated in FIG. 2, power drawn off from the power source 101 can supply power to electrical loads 224 (e.g., electric devices and systems) of a home 226 during a power outage (e.g., an emergency) and/or in a remote location when power generally supplied by a utility or other commercial provider is unavailable (e.g., off-grid locations) and/or unreliable. The power source 101 and/or the charging module 106 can be connected to the electrical loads 224 via a cable or connector (e.g., the connector 112). For example, one end of the connector 112 can be connected to the vehicle 100 and the opposite end to the external power source 108 (e.g., via an electrical outlet, an electrical panel, circuit and/or a main utility grid, e.g., of the house 226. The electrical loads 224 can include, but are not limited to, a refrigerator, heating, ventilation, and air conditioning systems (e.g., HVAC systems), light fixtures, garage doors, elevators, computers, printers, televisions and other types household electrical devices.

The flow of power can be reversed (e.g., switched) from charging the power source 101 to being drawn off the power source 101 by one or more switches 118 (e.g., manual, automatic, on-board the vehicle, and/or off-board the vehicle) of the charging system 102 configured to reverse the flow of power between the power source 101 and external power source 108 (e.g., an electrical outlet, an electrical panel, and/or a main utility grid, e.g., of a house). For example, power (e.g., DC) can be supplied from the power source 101 and converted by the charging module 106 to power (e.g., AC) that can be supplied to (e.g., via the connector 112) and used by the electrical loads 224 of the house 226.

In the illustrated embodiments, the charging system 102 includes a manual switch 118 positioned on-board the vehicle 100 that can be operated (e.g., flipped or manipulated) by a user or driver. In some embodiments, a switch 118 can be positioned off-board the vehicle 100 (e.g., on the connector 112) in addition to or in place of the manual switch 118 on-board the vehicle 100. In some embodiments, the charging system 102 can include one or more automatic switches 118 positioned on-board and/or off-board the vehicle 100 (e.g., in addition to or in place of the manual switches 118) configured to automatically switch the flow of power in response to signals from the one or more sensors 120 that can be configured to sense a power outage, power level of the power source 101 and/or of the motor 104 is in operation (e.g., turning). In response to the signals, the switches 118 can automatically switch, shut off, and/or decrease the flow of power to and/or from the power source 101. In other embodiments, a user can also manually operate the switches 118 in response to the signals from the sensors 120. The one or more sensors 120 can be coupled to the external power source 108, the motor 104, the charging module 106, the power source 101, the connectors 112, and/or the charge port 122.

In one embodiment, the output from each of the power blocks 140-142 is coupled to a plurality of charger ports 122a, 122b, 122c, etc., via switching system 150. In one embodiment, switching system 150 includes a plurality of contactors, or semiconductor switches, or other switching means, that allow the output from each of the power blocks to be electrically connected to any of the charger ports 122. Preferably switching system 150, or a control system that operates switching system 150, does not allow one charging port, to be coupled to another charging port. Using switching system 150, the amount of power that is coupled to a particular vehicle, via a charger port, may be tailored depending upon vehicle needs, charger port use, vehicle charging priority, fees, etc. In one embodiment, a controller 160, coupled to switching system 150, determines the distribution of power from the power blocks to the charger ports by applying a predefined set of distribution rules recorded in memory 175. In at least one embodiment, controller 160 is a processor-based control system (e.g., microprocessor) and memory 175 is a flash memory, solid state disk drive, hard disk drive, or other memory type or combination of memory types. Also coupled to controller 160 is a system monitor 180 which continually monitors the charging system, including vehicle/port conditions. In particular, system monitor 180 continually monitors ports 122a, 122b, 122c, etc., in order to determine when a vehicle is coupled to the charging system. Preferably system monitor 180 also obtains vehicle information through the ports, although such information may also be provided via other means (e.g., wireless network, vehicle ID such as an RFID tag, etc.). Preferably the vehicle information obtained through these means will include vehicle battery capacity, current state-of-charge (SOC), desired SOC, charging capabilities of the battery, battery temperature, etc. In one embodiment, system monitor 180 also is coupled to the power stages, or power blocks, in order to obtain power output/capabilities of each stage and/or block, monitoring for changing output conditions or problems within a stage/block. In at least one embodiment, system monitor 180 also monitors the input line in order to detect line problems. System monitor 180 may also include, or be coupled to, subsystem 185 which determines charging fees. Charging fees may vary based on the time of day, the cost of the power provided by the power source 101, or based on other conditions. Preferably system monitor 180 also includes one or more subsystems 186 for accepting money from the end user and, in at least some cases, determining an amount of money input by the end user. For example, subsystem 186 may be capable of accepting cash from the end user and determining how much cash was input. Subsystem 186 may also be capable of accepting credit cards or debit cards or other forms of non-cash payment. Preferably system monitor 180 also includes a subsystem 187 for updating distribution instructions or other aspects of charging system 102. Subsystem 187 may include either a wireless or wired internet connection. Subsystem 187 may also utilize a different communication system/protocol for obtaining system updates.

In a charging system with three power blocks, and assuming that each power block is configured to output the same amount of power, the power can be distributed at four different levels; 0 output, ⅓ Pₘₐₓ, ⅔ Pₘₐₓ, and Pₘₐₓ, where Pₘₐₓ is equal to the maximum available power from charging system, i.e., with all three power blocks coupled to a single port. As a result of this design, and as noted above, controller 160 can distribute the available power to the vehicles coupled to the charger's ports in a variety of different ratios depending upon the criteria used by the control system to determine power distribution.

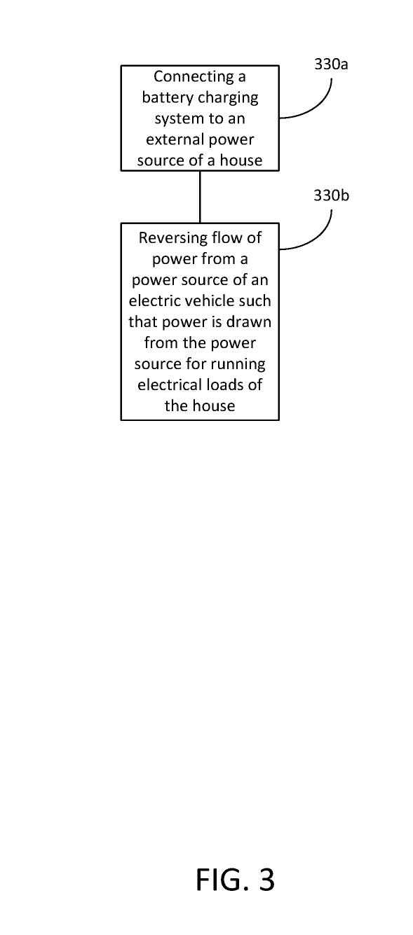

FIG. 3 schematically illustrates a method of operating the battery charging system 102 to power the electrical loads of a house in accordance with an embodiment of the present technology. The method can include connecting the battery charging system 102 to the external power source 108 of the house 226 (330a). Reversing flow of electric power such that power from a power source 101 of an electric vehicle 100 is drawn from the power source 101 for running electrical loads of the house 226 (330b) (e.g., during a power outage) instead of charging the power source 101.

In one aspect of the battery charging system 102, power from the power source 101 is used to power the electrical loads 224 of the house 226 during power outages. In certain embodiments, the battery charging system 102 is configured to be operated in such a manner only when the vehicle 100 is not running (e.g., the motor 104 is not turning). In other embodiments, the battery charging system 102 is configured to be operated in such a manner when the vehicle 100 is both running or not running.

Although the foregoing embodiment illustrates one possible use of the battery charging system 102 (e.g., for providing backup power to a house 226), those of ordinary skill in the art will appreciate that the battery charging system 102 and/or other devices or components disclosed herein can be used in a wide variety of different environments, systems and/or applications. Such systems or applications can include, for example, renewable energy systems, recreational vehicles (RVs), mobile homes, camping sites, construction sites or other remote locations, office buildings, industrial buildings, hospitals, farms, factories, gas stations, rest stops, schools, and for other emergency or backup applications.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

1. A battery charging system comprising one or more charging modules configured to convert power transmitted from an external power source into power that is storable by a rechargeable battery of a vehicle.

2. The battery charging system of claim 1 wherein the external power source comprises household power and/or power transmitted from a vehicle charging station.

3. The battery charging system of claim 2 wherein the vehicle charging station is a supercharging station.

4. The battery charging system of claim 1 wherein the charging module is configured to be connected to the external power source via one or more connectors.

5. The battery charging system of claim 1 wherein the charging module is configured to be connected to the rechargeable battery via one or more connectors.

6. The battery charging system of claim 1 wherein the power transmitted from the external power source comprises alternating current power.

7. The battery charging system of claim 1 wherein the power that is storable by the rechargeable battery of the vehicle comprises direct current power.

8. The battery charging system of claim 1 wherein the charging module is configured to convert direct current power from the rechargeable battery of the vehicle to alternating current power that is usable by an electric motor of the vehicle or by the external power source.

9. The battery charging system of claim 1 wherein the charging module is configured to supply backup power from the rechargeable battery of the vehicle to the external power source.

10. The battery charging system of claim 1 wherein the charging module is configured to supply backup power from the rechargeable battery of the vehicle to the external power source in the case of a power outage at the external power source.

11. The battery charging system of claim 1 wherein the charging system comprises a switch for reversing flow of power between the rechargeable battery of the vehicle and the external power source.

12. The battery charging system of claim 1 wherein the charging module comprises a sensor for sensing a power outage at the external power source, wherein the charging module is configured to supply power to the external power source in response to a power outage signal from the sensor.

13. A method of supplying backup power from a vehicle battery charging system to a household power grid comprising, connecting a vehicle battery to the vehicle battery charging system, connecting the vehicle battery charging system to the household power grid, and reversing flow of electric power such that the vehicle battery charging system draws power from the vehicle battery and delivers power to the household power grid.

14. The method of claim 13 wherein flow of electric power is automatically reversed such that the vehicle battery charging system draws power from the vehicle battery and delivers power to the household power grid in response to a signal received from the vehicle battery charging system that there is a power outage at the household power grid.
